(19) United States
(12) Patent Application Publication
(10) Pub. No.: US 2015/0102256 A1
(43) Pub. Date: Apr. 16, 2015

(54) CATHODE ACTIVE MATERIAL FOR LITHIUM-ION SECONDARY BATTERY

(71) Applicants: Hiroaki Konishi, Tokyo (JP); Akira Gunji, Tokyo (JP); Xiaoliang Feng, Tokyo (JP)

(72) Inventors: Hiroaki Konishi, Tokyo (JP); Akira Gunji, Tokyo (JP); Xiaoliang Feng, Tokyo (JP)

(73) Assignee: Hitachi, Ltd., Tokyo (JP)

(21) Appl. No.: 14/404,121

(22) PCT Filed: May 31, 2012
(86) PCT No.: PCT/JP2012/064114

§ 371 Date: Nov. 26, 2014

(51) Int. Cl. H01M 4/505; H01M 4/525

(52) U.S. Cl. CPC H01M 4/505; H01M 4/525
USPC 252/182.1

(57) ABSTRACT

A cathode active material is provided which is capable of improving charge/discharged potential and increasing energy density. The cathode active material is for a lithium-ion secondary battery and is represented by the composition formula: xLi₂MnO₃-(1−x)LiNiₐMn_{b}O₂. In the composition formula, x, a, and b are numerals satisfying the following relationships: 0.2<x<0.8, 0.5<a<1, 0<b<0.5, and a+b=1.

### TECHNICAL FIELD

The present invention relates to: a cathode active material for a lithium-ion secondary battery; and a lithium-ion secondary battery including the cathode active material.

### BACKGROUND ART

In recent years, from the prevention of global warming and concern over the exhaustion of fossil fuel, an electric automobile requiring small energy for travel is increasingly expected. The following technological problems exist however in such technologies and an electric automobile does not yet become popular.

A problem of an electric automobile is that the energy density of a driving battery is low and the travel distance at one charge is short. Consequently, a secondary battery of a low price and a high energy density is desired.

A lithium-ion secondary battery has a higher energy density per weight than a secondary battery such as a nickel hydrogen battery or a lead battery. Consequently, the applications of a lithium-ion secondary battery to an electric automobile and an electric power storage system are expected. In order to respond to the request of an electric automobile however, a yet higher energy density is required. In order to materialize a higher energy density of a battery, it is necessary to increase the energy densities of a cathode and an anode.

As a background art in the present technological field, there is Patent Literature 1 for example. Patent Literature 1 describes an active material for a lithium secondary battery containing a solid solution of lithium transition metal composite oxide having a composition ratio of Li, Co, Ni, and Mn satisfying the expression Li_{1+(1/3)x}Co_{1-x-y}Ni_{(1/2)y}Mn_{(2/3)x+(1/2)y}.

### CITATION LIST

### Patent Literature

Patent Literature 1: Japanese Published Unexamined Application No. 2011-146392

### SUMMARY OF INVENTION

### Technical Problem

An object of Patent Literature 1 is to provide an active material for a lithium secondary battery capable of increasing a discharged capacity in a potential region of 4.3 V or lower. The discharged capacity described in Patent Literature 1 however is a value obtained when a discharge cutoff potential is reduced up to 2.0 V and hence the value is highly likely to be insufficient when the value is converted into an energy density.

In view of the above situation, an object of the present invention is to provide a cathode active material capable of improving a discharged potential and increasing an energy density.

### Solution to Problem

The present inventors, as a result of earnest studies, have found that the above object can be attained by a cathode active material for a lithium-ion secondary battery represented by the composition formula:

xLi₂MnO₃-(1−x)LiNiₐMn_{b}O₂,

[in the formula, x, and b are numerals satisfying the following relationships:
0.2<x<0.8,
0.5<a<1,
0<b<0.5, and
a+b=1].

### Advantageous Effects of Invention

The present invention makes it possible to provide a cathode active material capable of increasing an energy density.

### BRIEF DESCRIPTION OF DRAWING

FIG. 1 is a sectional view schematically showing the structure of a lithium-ion secondary battery.

### DESCRIPTION OF EMBODIMENTS

### Cathode Active Material

A lithium-ion secondary battery is required to have a high energy density when it is adopted in an electric automobile. In a lithium-ion secondary battery, the characteristic is closely related with a cathode active material.

A Cathode active material for a lithium-ion secondary battery according to the present invention is represented by the composition formula:

xLi₂MnO₃-(1−x)LiNiₐMn_{b}O₂,

[in the formula, x, a, and b are numerals satisfying the following relationships:
0.2<x<0.8,
0.5<a<1,
0<b<0.5, and
a+b=1].
By having such a composition, it is possible to attain a high energy density.

x in the composition formula represents a proportion of Li₂MnO₃ in xLi₂MnO₃-(1−x)LiNiₐMn_{b}O₂. If x is not more than 0.2, a high capacity cannot be obtained. If x is not less than 0.8 in contrast, the proportion of Li₂MnO₃ that is electrochemically inactive increases, hence the resistance of a cathode active material increases, and the capacity reduces.

a in the composition formula represents a content ratio (atomic weight ratio) of Ni in a cathode active material. If a is not more than 0.5, the content ratio of Ni that contributes mostly to charge and discharge reaction reduces and the capacity reduces.

b in the composition formula represents a content ratio (atomic weight ratio) of Mn in a cathode active material. If b is not less than 0.5, the content ratio of Ni that contributes mostly to charge and discharge reaction reduces and the capacity reduces.

In order to further increase an energy density, a, and b in the composition formula are numerals satisfying the following relationships:

preferably
0.4≦x≦0.6,
0.525≦a≦0.75,
0.25≦b≦0.475, and
a+b=1;
yet preferably
0.4≦x≦0.6,
0.525≦a≦0.7,
0.3≦b≦0.475, and
a+b=1;
still preferably
0.45≦x≦0.55,
0.525≦a≦0.7,
0.3≦b≦0.475, and
a+b=1; and
particularly preferably
0.45≦x≦0.55,
0.6≦a≦0.65,
0.35≦b≦0.4, and
a+b=1.

In an embodiment according to the present invention, a cathode active material contains only Li, Ni, and Mn as the transition metals but does not contain Co. Since Co is expensive, a cathode active material according to the present embodiment has the advantages of a high energy density and a low cost.

A cathode active material according to the present invention can be expressed also as a solid solution of Li₂MnO₃, LiNiO₂, and LiMnO₂. Here, a simple mixture of Li₂MnO₃ powder, LiNiO₂ powder, and LiMnO₂ powder is clearly distinguished from a solid solution.

A cathode active material according to the present invention can be manufactured by a method generally used in the technological field to which the present invention belongs. For example, it can be manufactured by mixing chemical compounds containing Li, Ni, and Mn respectively at an appropriate ratio and baking them. The composition of a cathode active material can be adjusted appropriately by changing the ratio of the mixed chemical compounds.

As a chemical compound containing Li, lithium acetate, lithium nitrate, lithium carbonate, lithium hydroxide, or the like can be named for example. As a chemical compound containing Ni, nickel acetate, nickel nitride, nickel carbonate, nickel sulfate, nickel hydroxide, or the like can be named for example. As a chemical compound containing Mn, manganese acetate, manganese nitrate, manganese carbonate, manganese sulfate, manganese oxide, or the like can be named for example.

The composition of a cathode active material can be decided through element analysis by an inductively-coupled plasma (ICP) method or the like for example.

<Lithium-Ion Secondary Battery>

A lithium-ion secondary battery according to the present invention is characterized by containing an aforementioned cathode active material. A lithium-ion secondary battery having a high energy density can be obtained by using the cathode active material for a cathode. A lithium-ion secondary battery according to the present invention can be used preferably for an electric automobile for example.

A lithium-ion secondary battery comprises a cathode including a cathode active material, an anode including a negative active material, a separator, an electrolyte, an electrolyte, and others.

A negative active material is not particularly limited as long as it is a material capable of storing and discharging lithium ions. A material generally used in a lithium-ion secondary battery can be used as a negative active material. For example, graphite, lithium alloy, etc. can be named.

As a separator, a material generally used in a lithium-ion secondary battery can be used. For example, microporous film, non-woven fabric, etc. made by polyolefin such as polypropylene, polyethylene, or a copolymer of propylene and ethylene can be named.

As an electrolyte and an electrolyte, materials generally used in a lithium-ion secondary battery can be used. For example, as an electrolyte, diethyl carbonate, dimethyl carbonate, ethylene carbonate, propylene carbonate, vinylene carbonate, methyl acetate, ethyl methyl carbonate, methyl propyl carbonate, dimethoxy ethane, or the like can be named. As an electrolyte, LiClO₄, LiPF₆, LiBF₄, LiAsF₆, LiSbF₆, LiCF₃SO₃, LiC₄F₉SO₃, LiCF₃CO₂, Li₂C₂F₄(SO₃)₂, LiN(CF₃SO₂)₂, LiC(CF₃SO₂)₃, or the like can be named.

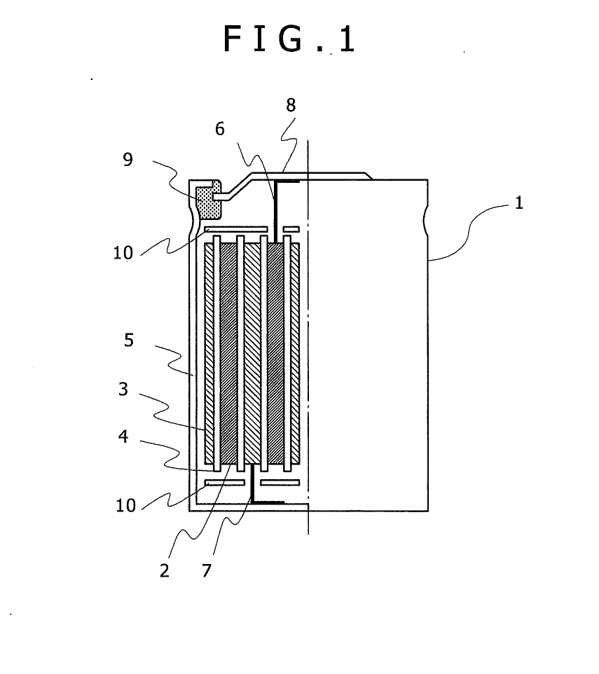

An embodiment of the structure of a lithium-ion secondary battery according to the present invention is explained in reference to FIG. 1. A lithium-ion secondary battery 1 is provided with an electrode group comprising a cathode 2 formed by coating both the surfaces of a collector with a cathode active material, an anode 3 formed by coating both the surfaces of a collector with a negative active material, and a separator 4. The cathode 2 and the anode 3 are wound in the manner of interposing the separator 4 and thus the electrode group of a wound body is formed. The wound body is inserted into a battery can 5.

The anode 3 is electrically coupled to the battery can 5 through an anode lead terminal 7. A sealed lid 8 is attached to the battery can 5 through a packing 9. The cathode 2 is electrically coupled to the sealed lid 8 through a cathode lead terminal 6. The wound body is insulated by insulating plates 10.

Here, the electrode group may not be a wound body shown in FIG. 1 and may also be a laminated body formed by stacking a cathode 2 and an anode 3 while a separator 4 is interposed.

### EXAMPLES

The present invention is hereunder explained further in detail in reference to examples and comparative examples but the technological scope of the present invention is not limited to those.

<Manufacturing Cathode Active Material>

A precursor is obtained by dissolving lithium acetate, nickel acetate, and manganese acetate in purified water and thereafter being splay-dried with a splay dryer. A lithium transition metal oxide is obtained by baking the obtained precursor at 500° C. for 12 hours in the atmosphere. The obtained lithium transition metal oxide is pelletized and thereafter baked at 900° C. to 1,050° C. for 12 hours in the atmosphere. The baked pellet is pulverized in an agate mortar and classified with a sieve of 45 μm and thus a cathode active material is obtained.

The compositions of the cathode active materials used in the examples and the comparative examples are shown in Table 1.

TABLE 1
Composition formula: xLi₂MnO₃—(l-x)LiNiₐMn_{b}O₂

| | x | a | b |
|---|---|---|---|
| Example 1 | 0.5 | 0.625 | 0.375 |
| Example 2 | 0.5 | 0.525 | 0.475 |
| Example 3 | 0.5 | 0.75 | 0.25 |
| Example 4 | 0.4 | 0.625 | 0.375 |
| Example 5 | 0.6 | 0.625 | 0.375 |
| Comparative example 1 | 0.5 | 0.5 | 0.5 |
| Comparative example 2 | 0.5 | 1 | 0 |
| Comparative example 3 | 0.2 | 0.625 | 0.375 |
| Comparative example 4 | 0.8 | 0.625 | 0.375 |

<Manufacturing Trial Battery>

In the examples and the comparative examples, cathodes are manufactured by using the nine kinds of cathode active materials manufactured as stated above and the nine kinds of trial batteries are manufactured.

Cathode slurry is manufactured by uniformly mixing each of the cathode active materials, a conductivity aid, and a binder. The cathode slurry is applied over an aluminum collector foil 20 μm in thickness, dried at 120° C., and subjected to compression molding with a press so that the electrode density may be 2.2 g/cm³, and thus an electrode plate is obtained. Successively, the electrode plate is punched into a disc 15 mm in diameter and thus a cathode is manufactured.

An anode is manufactured by using metal lithium. As a non-aqueous electrolyte, a substance produced by dissolving LiPF₆ at a concentration of 1.0 mol/L in a solvent produced by mixing ethylene carbonate and dimethyl carbonate at a volume ratio of 1:2 is used.

<Charge and Discharge Test>

In the examples and the comparative examples, charge and discharge test is applied to each of the nine kinds of trial batteries manufactured as stated above.

Charge and discharge test is applied to a trial battery under the conditions of an electric current equivalent to 0.05 C and an upper limit voltage of 4.8 V when it is charged and an electric current equivalent to 0.2 C and a lower limit voltage of 3.2 V when it is discharged. A value obtained by dividing a discharged capacity obtained in each of the examples and the comparative examples by the discharged capacity obtained in the comparative example 1 is defined as a discharged capacity ratio. The results are shown in Tables 2 and 3.

TABLE 2

| | Discharged capacity ratio |
|---|---|
| Example 1 | 1.15 |
| Example 2 | 1.08 |
| Example 3 | 1.01 |
| Comparative example 1 | 1 |
| Comparative example 2 | 0.97 |

TABLE 3

| | Discharged capacity ratio |
|---|---|
| Example 1 | 1.15 |
| Example 4 | 1.06 |
| Example 5 | 1.03 |
| Comparative example 3 | 0.75 |
| Comparative example 4 | 0.67 |

As shown in Table 2, the discharged capacities improve in the examples 1 to 3 in comparison with the comparative example 1. In contrast, the discharged capacity reduces in the comparative example 2.

Further as shown in Table 3, the discharged capacities improve in the examples 4 and 5 in comparison with the comparative example 1. In contrast, the discharged capacities reduce in the comparative examples 3 and 4.

As stated above, by adjusting the composition of a cathode active material, it is possible to obtain a high discharged capacity even in a region of a high potential not lower than 3.2 V and increase an energy density.

All the publications, patents, and patent applications quoted in the present description are incorporated herein by reference in its entirety.

### LIST OF REFERENCE SIGNS

1 Lithium-ion secondary battery
2 Cathode
3 Anode
4 Separator
5 Battery can
6 Cathode lead terminal
7 Anode lead terminal
8 Sealed lid
9 Packing
10 Insulating plate

1. A cathode active material for a lithium-ion secondary battery, wherein said cathode active material is represented by the composition formula:
xLi₂MnO₃-(1−x)LiNiₐMn_{b}O₂,
wherein x, a, and b are numerals satisfying the following relationships:
0.2<x<0.8,
0.5<a<1,
0<b<0.5, and
a+b=1.

2. The cathode active material for a lithium-ion secondary battery according to claim 1, wherein x, a, and b are the numerals satisfying the following relationships:
0.4≦x≦0.6,
0.525≦a≦0.75,
0.25≦b≦0.475, and
a+b=1.

3. The cathode active material for a lithium-ion secondary battery according to claim 1, wherein x, a, and b are the numerals satisfying the following relationships:
0.4≦x≦0.6,
0.525≦a≦0.7,
0.3≦b≦0.475, and
a+b=1.

4. The cathode active material for a lithium-ion secondary battery according to claim 1, wherein x, a, and b are the numerals satisfying the following relationships:
0.45≦x≦0.55,
0.525≦a≦0.7,
0.3≦b≦0.475, and
a+b=1.

5. The cathode active material for a lithium-ion secondary battery according to claim 1, wherein x, a, and b are the numerals satisfying the following relationships:
0.45≦x≦0.55,
0.6≦a≦0.65,
0.35≦b≦0.4, and
a+b=1.

6. The lithium-ion secondary battery including a cathode active material for a lithium-ion secondary battery according to claim 1.
